(19) United States
(12) Patent Application Publication
(10) Pub. No.: US 2007/0016928 A1
(43) Pub. Date: Jan. 18, 2007

(54) CREATING MEDIA CONTENT WITH SELECTABLE COMPONENTS

(76) Inventors: Darren L. Wesemann, North Salt Lake, UT (US); Jeffrey Hays, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/425,374

(22) Filed: Jun. 20, 2006

Related U.S. Application Data
(63) Continuation-in-part of application No. 11/383,921, filed on May 17, 2006.
(60) Provisional application No. 60/682,361, filed on May 18, 2005.

(51) Int. Cl. H04N 7/10; G06F 3/00; G06F 13/00; H04N 7/025; H04N 5/445

(52) U.S. Cl. 725/46; 725/34; 725/35

(57) ABSTRACT

Generating individualized media content using selectable content from subject matter experts. A knowledge base includes content from various subject matter experts. Methods defined by subject matter experts are associated with media clips. A subset of methods are selected from the knowledge base according to subscriber attributes. The subset of methods is distilled by applying rules. The resulting methods are organized using a template. The clips associated with the methods in the template are then mixed together to generate the individualized media content that is then delivered to the subscriber. Subsequent media content can also be individualized using the subscriber's attributes, which includes feedback from prior media content.

### CROSS-REFERENCE TO RELATED APPLICATIONS

This application is a continuation in part of U.S. patent application Ser. No. 11/383,921 filed May 17, 2006 and entitled MIXING AND PRODUCING INDIVIDUALIZED MEDIA FILES, which application claims the benefit of U.S. Provisional Patent Application Ser. No. 60/682,361 filed May 18, 2005. The foregoing applications are incorporated herein by reference in their entirety.

### BACKGROUND OF THE INVENTION

1. The Field of the Invention

The present invention relates to the field of media content. More particularly, embodiments of the invention relate to systems and methods for creating individualized content from selectable components including media clips.

2. The Relevant Technology

People today have interests that can vary widely from one person to the next Some people are interested in learning, others are interested in travel, and still others enjoy exercising. These types of activities can bring satisfaction to our lives. As a result, people often strive to improve in areas or activities they are familiar with as well as try new activities. One of the best ways to achieve good results in a given activity is to seek advice or suggestions from someone that is an expert in the relevant subject.

For example, cooking schools have expertise in teaching people to cook, colleges provide professors for a wide variety of subjects, travel agents are familiar with trip destinations, and trainers are able to improve the way one exercises. In each of these cases, the subject matter expert is able to help people achieve their goals. It makes sense that a chef can teach one to cook or that a trainer can provide instruction to help one achieve his or her fitness goals.

The experience and expertise of a subject matter expert can help us in a variety of ways. Subject matter experts, for example, often have the ability of being able to identify a preferred course of conduct or a preferred course of study. One of the attractions of personal trainers, and of fitness clubs in general, is their ability to motivate their subscribers and to achieve better results than the subscriber can alone.

Unfortunately, seeking and obtaining the service of a subject matter expert can often prove difficult and expensive. For example, one wanting to achieve a fitness goal would probably seek a trainer, who is a subject matter expert for exercise or fitness. There are several reasons, however, that may prevent one from seeking the assistance of a personal training. For example, the cost of personal trainers, the current demand for personal trainers, scheduling conflicts, travel issues, and the like are examples of reasons why a particular subscriber may not be able to find and benefit from the experience and expertise of a personal trainer. As a result, may subscribers are left without the support and instruction needed to achieve desired fitness goals.

One attempt to fill this void can be found, for example, in DVDs, videocassettes, and the like. For example, people that want to exercise in their own homes can easily secure the necessary exercise equipment and can exercise to a workout DVD. Even though the DVD may have content that may have been prepared by a subject matter expert, it is difficult if not impossible to alter the content of the DVD. In other words, the DVD is typically mass produced and is not individualized for a particular user.

A DVD is often unable to dynamically adapt to the changing circumstances of a user. Thus, the needs of a particular subscriber may be only partially satisfied, especially when the subscriber advances past what the DVD has to offer. In other words, a DVD does not target specific individuals or the needs of specific individuals, but is typically targeted at a wide audience. The ability to bring the expertise of a subject matter expert in a dynamic way is lacking in existing technology and there is therefore a need to create instructions and personalized content in a portable medium to allow a subscriber to take a personalized media content with them in any location and for any subject.

### BRIEF SUMMARY OF THE INVENTION

These and other limitations are overcome by embodiments of the invention, which relate to systems and methods for generating individualized media content using selectable components. In one example, the selectable components are media clips (e.g., audio and/or video clips) that can be selected for inclusion in the individualized media content using attributes associated with a subscriber. Thus, the selected clips or components are specifically selected for that subscriber.

Embodiments of the invention use a knowledge base, which is a database that stores various types of content from subject matter experts. Some of the content is used as building blocks by certain subject matter experts to create methods. The knowledge base also includes clips associated with the methods. Whatever the subject of the knowledge base, the generated media content can be comprised of multiple methods. When the subject of the knowledge base is exercise, for example, the subject matter experts are trainers and the individualized media content is typically a workout routine. Each portion of the workout routine can be generated from multiple methods that have been defined by the subject matter experts or that have been generating using the content from the subject matter experts to model the content.

embodiment, a subscriber has various attributes. Some of the attributes are static while others are variable and/or related to the subscriber's history. In the context of exercise, the history includes feedback from the user regarding past workout routines or includes the routines that were generated in the past. Using the subscriber's attributes, the knowledge base is accessed to identify those methods or to identify the data that matches or that at least partially matches the subscriber's attributes.

The resulting subset of methods or data can be further distilled by applying rules. The resulting methods are then organized into a workout routing using a template. The template may also be used to distill the subset of methods that resulted from querying the knowledge base using the subscriber's attributes. Once the template is populated with the methods, the clips corresponding to those methods can be mixed to create the individualized media content, which is then ready for use by the subscriber.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is an illustration of an expert system that uses a knowledge base to generate individualized media content for a subject;

FIG. 2 illustrates an example of an environment for implementing embodiments of the invention;

FIG. 3 illustrates an exemplary method for generating individualized media content from selectable components including selectable media clips;

FIG. 4 illustrates a general overview of a template used to construct the individualized media content;

FIG. 5 illustrates one embodiment of a template organization for an exercise routine;

FIG. 6 illustrates one embodiments of clips that have been selected and identified for inclusion in individualized media content; and

FIG. 7 illustrates an embodiment of a cadence outline that is included as part of a workout routine when the subject is exercise.

### DETAILED DESCRIPTION OF THE INVENTION

Embodiments of the invention relate generally to systems, methods, and/or computer program products for delivering individualized media content to a subscriber or other recipient and more particularly to systems and methods for creating media content with selectable components. Media content is typically created from a database, referred to herein as a knowledge base, that stores and/or incorporates content from different sources such as subject matter experts. Once the content from the various sources has been incorporated into the knowledge base, the knowledge base can be accessed based on certain parameters, such as a subscriber's attributes, to identify specific instances of the content, such as media clips. The media clips selected or identified from the knowledge base are aggregated using a template or table. The individualized media content can then be mixed from the template and provided individualized media content for a particular subject.

Embodiments of the invention are discussed below with reference to the subject of exercise or fitness. In the context of this subject, trainers are examples of subject matter experts (SMEs) that can provide content that can be modeled and incorporated into the knowledge base. One of skill in the art that the knowledge base can be adapted to other subjects and that appropriate subject matter experts can contribute content. As a result, embodiments of the invention can generated individualized media content for a wide variety of different subjects. Exemplary subjects include, but are not limited to, instructional or educational courses or content, sports activities, art, travel, entertainment, and the like or any combination thereof. The subject matter experts are those that have expertise or that have knowledge to share for a given subject. For example, a professor may be a subject matter expert for an educational course, while a travel agent may be a subject matter expert for travel. The subject matter experts can be identified from the subject included in the knowledge base.

The knowledge base includes content in various forms and formats from multiple users or entities. One of the users or category of users that provides content that is incorporated into the knowledge base is a SME. Some of the SMEs provide content that serves as building blocks, while other SMEs provide content by identifying specific combinations of the building blocks or by providing additional content. In the context of exercise, for example, the content that serves as building blocks may include generating tables in the knowledge base that define exercise equipment. Some of the SMEs can then provide content that may incorporate the defined exercise equipment into a routine in a manner that expresses the philosophies of the SMEs.

Further, the content provided or organized by the SMEs can be analyzed to generate patterns or philosophies that can also be used to generate media content from selectable components. As used herein, media content is one embodiment of an individualized media file that can include audio and/or video content. Typically the media content includes one or more media clips, each of which may include audio and/or video content, that are selected and then mixed according to some criteria, such as a subscriber's attributes. The content received from the subject matter experts is incorporated into the media clips such that, when the individualized media content is delivered, it includes specifically selected content from subject matter experts. Advantageously, subscribers of the media content can receive the benefit of content provided by one or more subject matter experts. In this manner, each subscriber can receive individualized media content.

Embodiments of the invention generate individualized media content that can be directed to a wide variety of activities or subjects. The knowledge base can therefore be created with different subjects in mind and the subject matter experts that contribute to a particular knowledge base are preferably knowledgeable or familiar with that particular subject matter.

Embodiments of the invention are described as they relate to the subject of exercise. In this example, the subject matter experts that contribute to the knowledge base include those that are knowledgeable about exercise, such as exercise trainers and the like. One of skill in the art can appreciate that the knowledge base can be related to other subjects in view of the present disclosure. For example, media content related to a course on algebra may include content from a subject matter expert such as a professor or teacher. Media content related to a trip may include content from a subject matter expert such as a travel guide. One of skill in the art can appreciate, with the benefit of the present disclosure, that the invention can be practiced with many different subjects, including various sessions and activities, in addition to the subject of exercise.

A subscriber that accesses and uses the system described herein ultimately receives individualized media content. When the subject is exercise, the media content delivered to a subscriber may be a workout routine that includes content from one or more subject matter experts. Embodiments of the invention can therefore deliver the expertise of a subject matter expert in the form of media content. Further, the individualized media content can be generated from selectable components stored in the knowledge base.

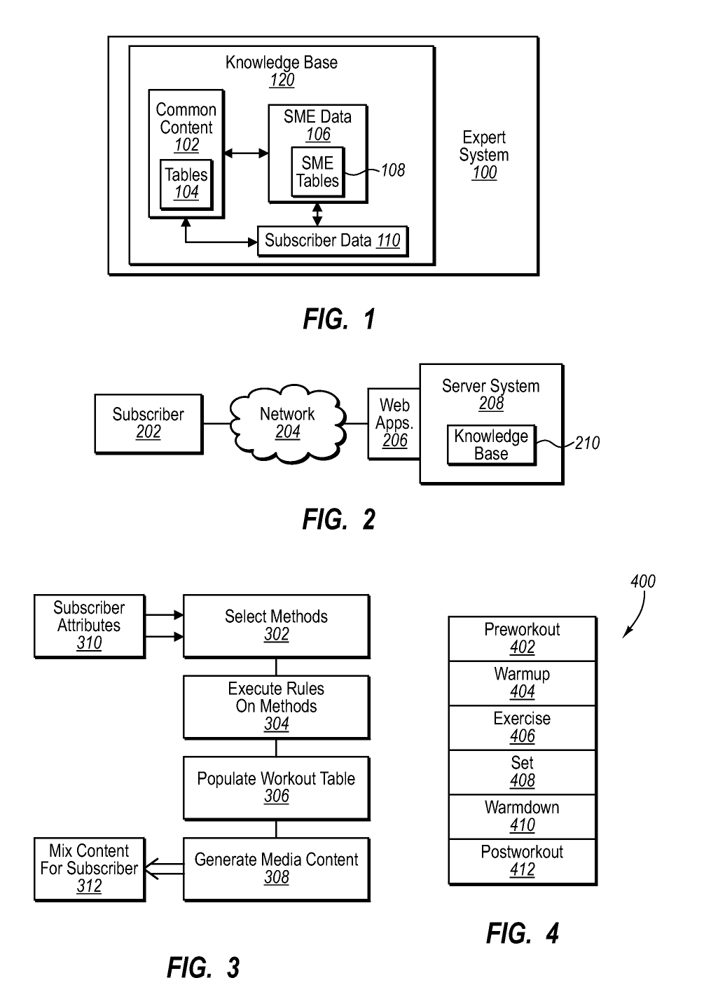

FIG. 1 illustrates one embodiment of an expert system 100 that includes a knowledge base 120. The knowledge base 120 is, in one embodiment, a relational database. The expert system 100 can perform queries and execute rules processing to produce output that conforms to the goals, attributes, and/or status of a subscriber. In one example, the output is individualized media content that can be transmitted to a subscriber.

The knowledge base 120 includes, in this example, common content 102, SME data 106, and subscriber data 110, each of which can be interrelated. The common content 102 is one embodiment of the building blocks of the knowledge base 120 that is typically provided by a first SME or by a group of SMEs that are responsible for generating, updating, maintaining, etc., the common content 102.

The common content 102 includes tables 104 used to store and/or reference various kinds of content in various forms including media clips. Exercises, for example, are defined in the common content 102 in terms of name, description, body part (chest, back, shoulder, biceps, triceps, etc.), equipment, progression (resistance, volume, distance, rate, etc.), and/or clip intro (recorded media). The common content 102 may also include tables related to exercise equipment, age group, cadence, endurance, experience level, frequency, goal, medical event, and the like or any combination thereof.

The SME tables 108 are similar to the tables 104. In one embodiment, the SME tables 108 are used to define methods, which involve the selection of an exercise from the common content 104 and the providing of attributes such as frequency, cadence, reps, sets, rests, age group, medical history, experience level, endurance level, fitness level, availability, and the like or any combination thereof. The methods generated from input from an SME can be stored in the knowledge base 120.

The knowledge base 120 also includes subscriber data 110. The attributes of the each subscriber can include name, gender, height, age group, goal, email, equipment available, medical history, weight, and the like or any combination thereof.

As illustrated in FIG. 2, a subscriber 202 can access the server 208 over a network 204 such as the Internet. The server 208 provides one or more applications 206 that are tailored to the identity of the person accessing or using the knowledge base 120. In other words, because the data provided by a subscriber is different from the data provided by an SME, the web application 206 also varies accordingly. In this example, the user interface presented to the subscriber 202 enables the subscriber 202 to enter, alter, update, delete, etc., the attributes previously identified.

Once a subscriber has entered his or her attributes, the expert system 100 can then begin the process of generating individualized media content. Generally stated, the expert system 120 can select all of the SME defined methods where subscriber attributes (both static, historic and/or variable) match the method attributes. For a subscriber that has a goal of losing weight, the expert system 100 can identify all methods in the knowledge base 120 that have the same attribute. As previously indicated, the SME may provide a goal attribute for each method. If the goal of the SME's method is losing weight in this example, then a match occurs for the subscriber. In order to generate a particular match, there is no requirement that all of the subscriber's attributes match exactly with the attributes of a method.

From the list of methods identified in this manner, one or more rules are executed. The rules may include ordering the returned methods, filtering the methods based on various attributes or other criteria. The resulting methods are then inserted into a template or table, which is used to produce the individualized media content.

The individualized media content can be created at the server system 208 or at the subscriber's client system. The client system may be a computer system that can communicate with the server system 208. Further, the client system may be any device capable of performing the individualized media content, which may include audio and/or video in various formats. The device may be a computer, a personal audio player, a personal video player, and the like or any combination thereof or other device capable of rendering or playing the individualized media content.

illustrates an exemplary flowchart from the perspective of a subscriber that desires to receive individualized media content, that in the subject of exercise, may represent an individualized workout routine. If the subject of the knowledge base were educational, the individualized media content may represent a discussion of a particular topic and homework problems that are tailored to the subscriber. One of skill in the art can appreciate, with the benefit of this disclosure, that the individualized media content can be tailored according to the subject and is not limited to exercise.

The inputs typically provided are the subscriber attributes 310. As previously stated, some of the subscriber attributes are static (i.e., date of birth, age, medical history, etc.). Some of the subscriber attributes are variable (age, weight, etc.). Some of the subscriber attributes can also include the subscriber's history. For example, a user may input the results of a previous workout routine, which may have an impact on the next workout routine generated by the expert system 100.

In this example, the subscriber attributes 310 are provided to the expert system 100 and/or have been previously entered. Using these attributes 310, the expert system 100 queries the knowledge base to select methods 302 that match the subscriber attributed 310. The result of the query is a subset of methods or a subset of data that may apply to the subscriber or that may be included in the individualized media content.

Once the methods have been selected, the expert system 100 executes rules 304 of the selected methods. The rules, in one embodiment, perform a distilling process on the selected methods. In one example, the rules are used to place specific methods (or IDs in one example, where each ID corresponds to a media clip) into a template or skeleton structure. The rules are the logic that choose the specific methods from the subset of methods that match the subscriber attributes.

For example, the expert system 100 may return several methods for a particular part of the template. The rules may review the history of the user to identify methods that have already been performed such that methods are not repeated until all have been selected at least once. The rules may examine the methods for information provided by the SME to identify those methods that may be more relevant than other methods. The rules can perform ordering of the selected methods and associated media clips, filtering of the selected methods and associated media clips, and the like.

The resulting sequence of methods is then used to populate a workout table 306, which is one embodiment of a template. In one embodiment, the workout table 306 is populated with identifiers that each correspond to a media clip. Next, the individualized media content is generated 308 by mixing all of the media clips that are identified in the workout table to generate the individualized media content which is the workout routine in this case. In some instances, the media content is mixed with background music and/or video to generate individualized media that can be delivered to the subscriber. In one embodiment, the individualized media content is an mp3 file. The generation of the media content can be server and/or client based.

FIG. 4 illustrates one embodiment of an exercise template 400. The template 400 can be filled from content such as media clips from the knowledge base. In this example, the template 400 includes a preworkout 402, a warmup 404, an exercise 406, a set 408, a warmdown 410 and a postworkout 412. The selection of media clips to include in each part of the template 400 is performed by the expert system 100 using the knowledge base as described above. Each portion of the template 400 may include more than one media clip that corresponds with one or more methods.

In another embodiment, a template can be populated with media clips that are determined as follows. The preworkout 402 is populated by querying a trainer record, which includes a preworkout media clip. The warmup 404 is populated by querying a warm table (used for both warmup and warmdown in one example) using a primary goal obtained from the subscriber goal table.

The exercise 406 portion of the template 400 is populated by querying the attributes of the method table (and associated link tables), matching the attributes of the methods against the attributes of the subscriber table to identify or obtain a list of appropriate exercises. Next, the trainer data is used to select the number and order of exercises from the identified methods. Applying the trainer data is an example of rules that are applied to selected methods. For each exercise, the appropriate media clip is obtained and inserted into the template or workout table.

The set 408 is obtained by querying a set table in the knowledge base using cadence and reps from the current exercise in order to obtain the appropriate counting media clip, which is then included in the set 408. The warmdown 410 is obtained by again querying the warm table using the primary goal obtained from the subscriber goal table. Finally, the postworkout 412 is obtained by querying the trainer tables, which contain the postworkout media clip. Once the template or workout table is populated, it can be mixed and delivered to the subscriber.

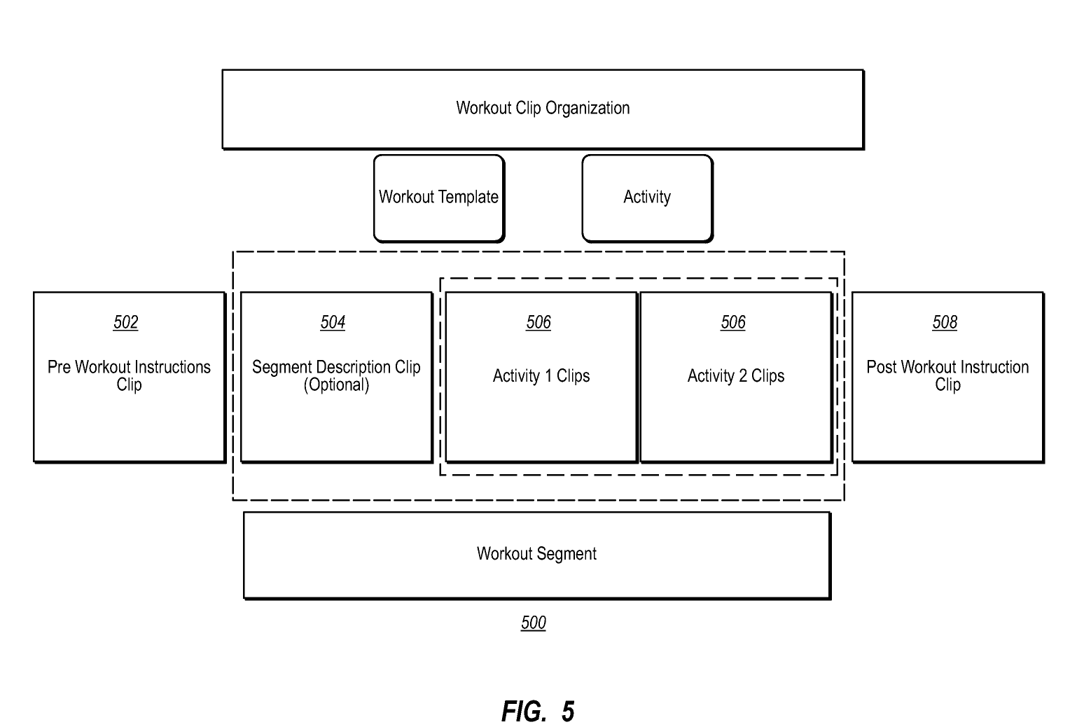

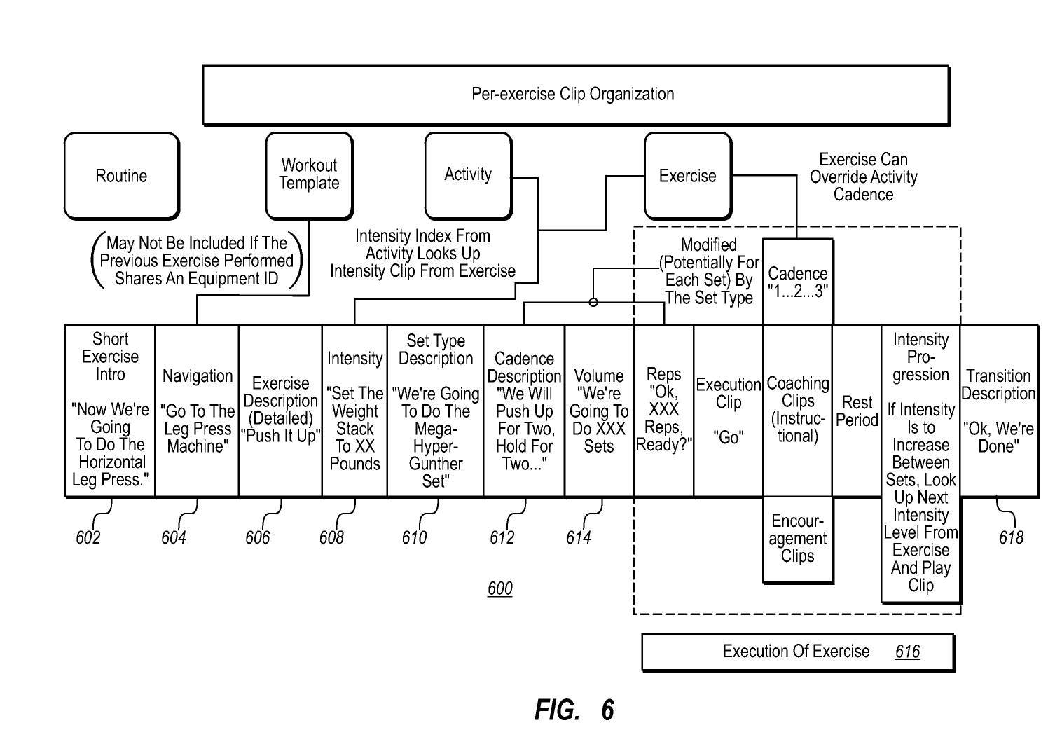

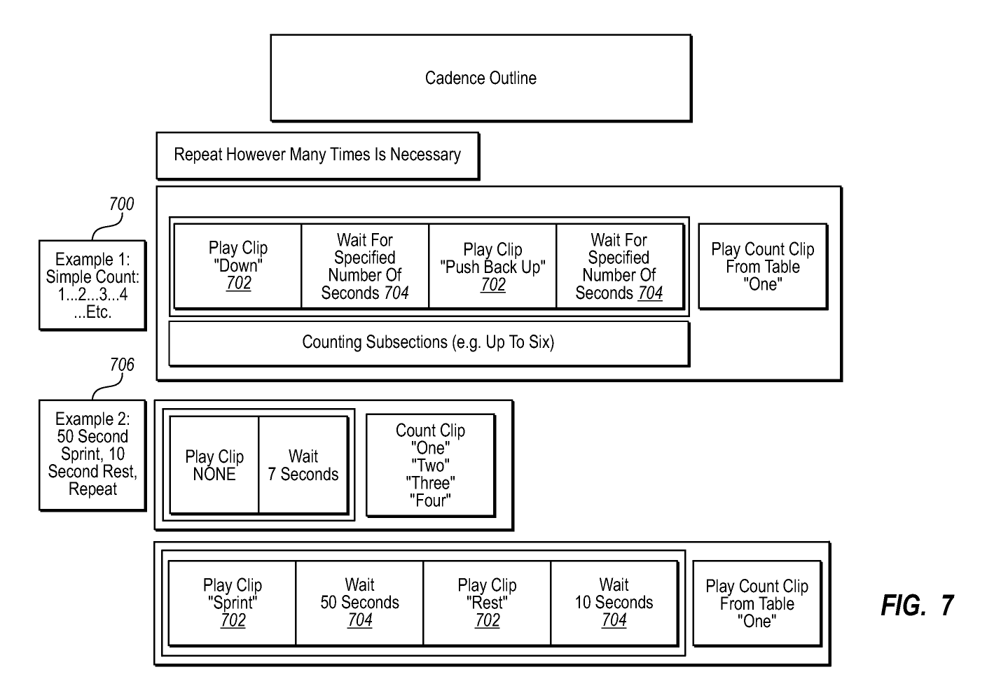

FIGS. 5, 6, and 7 provide additional details regarding the organization of the individualized media content generated for a subscriber and in particular to systems and methods for creating media content with selectable components such as media clips. FIG. 5 is a broad overview of a workout clip 500. FIG. 6 is a more detailed view of the contents of an exercise portion of the workout clip 500. And FIG. 7 is a detailed view of cadence examples in the workout clip 500.

Further, FIGS. 5-7 illustrate that individualized media content can include many different clips that are ultimately mixed together to create an individualized media content. A subscriber can have the ability to provide input that modifies the operation of the rules that distill matching data. For example, a subscriber may indicate that only methods or data from a particular trainer should be included in the media content. Alternatively, the subscriber may specify that certain attributes have priority over other attributes.

With reference to FIG. 5, the workout clip 500 can be composed of various media clips (also referred to herein as scriptlets) selected by the expert system or by a logic module of the expert system as described above. FIG. 5, for example, illustrates that a complete workout clip 500 may contain pre-workout instruction media clips 502 segment description media clips 504 exercise (activity) media clips 506, post-workout media clips 508 and pause media clips (not shown, but can be inserted as needed), etc. Cadence media clips may be used to effect the difficulty, speed, repetition, etc., of a workout. The specific clips in the workout clip 500 can be selected by the application of rules to selected data or clips that match a subscriber's attributes.

These media clips can be organized as discussed above, to include a preworkout introduction warm-up, exercise, introduction, sets, warm down, and post workout conclusion. The workout clip can use the trainer designed and subscriber matched workout templates and activities discussed above to select the individual media clips that match the subscriber's goals and profile attributes. Other embodiments of the workout clip 500 can include fewer or more media clips. Alternatively, some of the clips or segments can be combined.

Referring to FIG. 6, the more detailed example of a per-exercise clip portion 600 of work out clip 200 is illustrated. Per-exercise clips can be organized according to the template illustrated in FIG. 6 and the particular scriptlets or media clips can be selected based on the routines, workout templates, activity, and exercise data structures matched with the subscriber's profile attributes and goals using the trainer methods. The subscriber can also select a particular trainer, which can be an attribute of the subscriber and used to match the subscriber with particular clips or other data. The subscriber can also be matched with the particular trainer based on the subscriber's goals health, available equipment, and/or any other attributes of the subscriber. For example, where the subscriber has a particular health issue the subscriber can be matched with a particular trainer with goals and training philosophies tailored for the particular health issue of the subscriber. Subsequently the trainer's method data structures and scriptlets can be matched to the subscriber to create the individualized media program for the individual subscriber.

As indicated in FIG. 6, an exercise portion 616 of the assembled per-exercise clip 600 may only comprise of a portion of the overall per-exercise clip 600. Other portions of the per-exercise clip 600 may be included as shown, such as introductions 602, navigations 604, exercise descriptions 606, intensity clips 608, descriptions of the set type 610, cadence description describing the pace 612, volume description 614, and transition descriptions 618. Thus, there can be clips that have been matched with the subscriber that give detailed information and introduction to all aspects of the individualized workout for the subscriber.

FIG. 7 illustrates a block diagram showing various clips making up two example cadence outlines are illustrated. Example 1 (700) illustrates a simple cadence outline for a simple count type of exercise. As illustrated the cadence clip can include various instruction clips 702 interposed with various pause 704 clips. The duration of the various instruction clips 702 and pause clips 704 can be dependent on any variable in the system. For example, the type of exercise, philosophies of the trainers, and attributes of the subjects can be matched with different instruction clips 702 and pause clips 704 to control the pace and timing of the exercise according to the cadence example clips shown in FIG. 7.

The cadence clips can include more detailed instructions tailored to any aspect of an individualized media content. The cadence clips can include instructions that are tailored to the type of exercise, goals, subscriber attributes, trainer, etc. Example 2 (706) illustrated in FIG. 7 shows a block diagram of a sprint-rest cadence clip for a particular exercise. As shown, the instruction clips 702 and pause clip 704 durations are tailored for the particular type of exercise and duration of activity that is conduced in response to the respective instruction according to this example.

Generally, the expert system organizes and arranges a list of media clips according to the information for each clip to create a complete workout clip, such the clips illustrated in FIGS. 5-7, with the appropriate amount of scriptlets in the appropriate order according to the desired workout. As discussed above, the workout clip is associated with at least one of personal information, trainer information, exercise information, and general information to create a workout clip specifically personalized to the individual subscriber.

The list of clips generated contains a list of identifying information for each clip necessary to produce the final workout clip (e.g., see FIG. 5). A media clip creation module uses the information from the list from the template to retrieve the appropriate clips or scriptlets from the appropriate modules and data bases storing the scriptlets, and combines, or mixes, the individual scriptlets according to the template to create a complete workout clip. Media clip creation module may also use media supplied by the subscriber to mix a complete workout clip with background music selected by the subscriber, further personalizing the media clip. Music may, however, be selected by any entity of the system, such as subscriber, trainer, and knowledge engineer.

A workout clip may be stored on the subscriber's computer, accessible by the subscriber, and associated with a specific media organization program such as itunes®, or other similar software, for download of music files to a personal media device such as an ipod®, mp3 player, or other electronic device. A workout clip may then be played and utilized by subscriber to guide or assist with a workout. It should be appreciated that individualized video clips and combined video and audio clips of any format can also be assembled using the teachings set forth herein.

Although FIGS. 5-7 illustrate a workout routine, one of skill in the art can appreciate that the workout routine reflects the content or subject of the knowledge base. The process of generating the media content can be adapted to other subjects such that the resulting workout routing reflects the selected subject.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system including a subscriber that has access to a knowledge base for a subject, a method for generating individualized media content for the subscriber regarding the subject, the method comprising:
selecting a subset of methods from a knowledge base that includes one or more methods from one or more first subject matter experts regarding a first subject;
executing rules on the subset of methods to identify specific methods for inclusion in a template; and
populating the template with the specific methods.

2. The method of claim 1, wherein the knowledge base comprises common content provided by second subject matter experts, wherein the common content is used by the first subject matter experts to develop the methods stored in the knowledge base.

3. The method of claim 1, further comprising identifying one or more clips that correspond with the specific methods populating the template.

4. The method of claim 3, further comprising mixing the one or more clips to create an individualized media content.

5. The method of claim 1, wherein selecting a subset of methods from a knowledge base further comprises filtering methods in the knowledge base according to attributes of a subscriber, wherein the subset of methods includes methods having attributes that match at least one attribute of the subscriber.

6. The method of claim 1, wherein executing rules on the subset of methods further comprises distilling the subset of methods down to the specific methods.

7. The method of claim 1, wherein identifying a subset of methods from a knowledge base further comprises one or more of:
identifying one or more preworkout clips;
identifying one or more segment description clips;
identifying one or more activity clips;
identifying one or more cadence clips; or identifying one or more post workout clips.

8. The method of claim 1, wherein:
the subject is exercise and the first subject matter experts are trainers;
the subject is educational and the first subject matter experts are professors;
the subject is travel and the first subject matter experts are travel guides; or
the subject is an activity and the first subject matter experts have expertise in the activity.

9. A computer readable medium having computer executable instructions for performing the method of claim 1.

10. In a system that includes a knowledge base for a subject that includes content from subject matter experts, a method for generating individualized media content for a subscriber using the knowledge base, the method comprising:
receiving attributes of a particular subscriber;
accessing a knowledge base to identify a subset of clips that match at least one of the attributes of the particular subscriber;
applying one or more rules to the subset of clips to identify specific clips to be included in a template;
organizing the specific clips in the template; and
generating individualized media content from the specific clips in the template.

11. The method of claim 10, wherein receiving attributes of a particular subscriber further comprises updating variable attributes.

12. The method of claim 11, wherein the variable attributes include feedback from the particular subscriber related to previous media content generated and delivered to the particular subscriber.

13. The method of claim 10, wherein accessing a knowledge base further comprises accessing the knowledge base using the attributes of the particular subscriber, wherein each clip in the subset of clips matches at least one of the attributes of the particular subscriber.

14. The method of claim 10, wherein applying one or more rules to the subset of clips further comprises applying rules to ensure that different clips are included in the media content until all clips in the subset of clips have been used in at least once.

15. The method of claim 10, wherein applying the rules further comprises applying rules that are based on attributed selected by a subject matter trainer and/or by the particular subscriber.

16. The method of claim 10, wherein organizing the specific clips in the template further comprises selecting the appropriate template for the particular subscriber.

17. The method of claim 10, wherein accessing a knowledge base to identify a subset of clips that match at least one of the attributes of the particular subscriber further comprises:
identifying one or more preworkout clips;
identifying one or more segment description clips;
identifying one or more activity clips;
identifying one or more cadence clips; or
identifying one or more post workout clips.

18. The method of claim 10, wherein:
a subject of the knowledge base is at least one of an exercise, a educational course, a travel plan, or an activity and first subject matter experts that provide content to the knowledge base are at least one of trainers, professors, travel guides, or persons having expertise in the activity.

19. The method of claim 10, further comprising mixing the individualized media content with background music.

20. The method of claim 18, wherein the knowledge base includes common content from second subject matter experts that are used by the first subject matter experts as building blocks to create content for the knowledge base.

21. The method of claim 20, wherein the knowledge base further comprises one or more clips.

22. A computer readable medium having computer executable instructions for performing the method of claim 10.
